(19) United States
(12) Patent Application Publication
(10) Pub. No.: US 2022/0212039 A1
(43) Pub. Date: Jul. 7, 2022

(54) RECOVERY DEVICE

(71) Applicant: Brilliant Ideas Ltd, Bradley, Ashbourne, Derbyshire (GB)

(72) Inventor: Christopher Jon MASSEY, Derbyshire (GB)

(21) Appl. No.: 17/609,229

(22) PCT Filed: May 6, 2020
(86) PCT No.: PCT/GB2020/051111

§ 371 Date: Nov. 5, 2021

(30) Foreign Application Priority Data
May 8, 2019 (GB) 1906497.1

(51) Int. Cl. A62B 1/00; E04G 21/32

(52) U.S. Cl. CPC A62B 1/00; E04G 21/3266

(57) ABSTRACT

A recovery device (100, 200) for persons positioned above the ground, and a system (400) and method (300) including the recovery device (100, 200). The recovery device (100, 200) includes an expandable base portion (110, 210), and a person receiving portion (120, 220) configured to receive a person when the expandable base portion (110, 210) is expanded.

### TECHNOLOGICAL FIELD

Embodiments of the present disclosure relate to a recovery device for persons suspended in netting or positioned on a platform.

### BACKGROUND

When people are working at height, there is often netting provided between breaks in the working surface, to break the fall of a worker and prevent potential injury or death. For instance on a construction site netting may be provided between scaffolds or in a gap in a roof. The netting is often only able to support the weight of one person, and thus medical treatment cannot be initiated whilst the person is supported in the netting.

If a worker is rendered immobile by being knocked unconscious or suffering a cardiac arrest, it can be difficult to recover the worker from the netting to initiate medical treatment. When attempting to recover a person in the netting, workers are often instructed to hold a rigid board below the person in the netting, cut the netting around the person, then lower the board to the ground. This can be dangerous, as there is a high risk of the immobilised worker falling to the ground during the recovery, and the board may not provide adequate support for the immobilised worker.

A person might instead fall onto a platform located above ground such as a sloped roof of a house or a flat roof of a garage. It can be difficult to safely lower an immobile person from the platform to the ground.

### BRIEF SUMMARY

According to various, but not necessarily all, embodiments there is provided a system, comprising: netting for suspension from one or more support members; and a recovery device for positioning underneath the netting, including: an expandable base portion; and a person receiving portion configured to receive a person suspended in the netting when the expandable base portion is expanded.

The expandable base portion may be inflatable. The inflatable base portion may include an aperture and elongate fastening means mounted to the sides of the aperture, wherein the elongate fastening means is configured to close the aperture in the inflatable base portion in a fastened condition, and open the aperture in an unfastened condition, thereby enabling the inflatable base portion to be deflated when the fastening means is in an unfastened condition.

The inflatable base portion may comprise an inflatable bag including at least one baffle, wherein the at least one baffle connects the internal surface of the inflatable bag at a plurality of different locations, in order to retain the bag in a predetermined shape when inflated.

The person receiving portion may include a raised lip positioned around a central part of the person receiving portion, shaped to prevent a person received in the central part from falling out.

Possibly, the expandable base portion is configured to expand to at least 1 metre in height. Possibly, the expandable base portion is configured to expand to between 1 and 6 metres in height.

The person receiving portion may be inflatable. The recovery device may further comprise a one-way valve configured to inhibit airflow from the person receiving portion to the inflatable base portion and to enable airflow from the base portion to the person receiving portion.

The expandable base portion may include a plurality of handles to enable one or more users to hold the expandable base portion when expanded.

The person receiving portion may include fastening means for fastening a stretcher to the person receiving portion. The fastening means may be a plurality of clips. A stretcher may be provided, wherein the stretcher is mountable to the person receiving portion.

The system may further comprise inflation means for inflating the inflatable base portion and the person receiving portion.

According to various, but not necessarily all, embodiments there is provided a method for recovering persons suspended in netting comprising: positioning a recovery device below netting suspended from one or more support members, wherein the recovery device comprises: an expandable base portion; and a person receiving portion configured to receive a person suspended in the netting when the expandable base portion is expanded; expanding the expandable base portion to raise the person receiving portion substantially to the netting; disengaging at least a portion of the netting from the one or more support members; and contracting the expandable base portion.

The expandable base portion may be inflatable, and the expanding and contracting the inflatable base portion comprise inflating and deflating the inflatable base portion respectively.

The expandable base portion may be expanded to a height of at least 1 metre, and may be expanded to a height of between 1 and 6 metres.

Disengaging at least a portion of the netting from the one or more support members may include cutting the netting around the person receiving portion.

Elongate fastening means may be provided on the inflatable base portion, and the deflating of the inflatable base portion may include unfastening the elongate fastening means to allow air to escape the inflatable base portion.

The expandable base portion may include a plurality of handles, and the method may further comprise stabilising the inflatable base portion by holding the handles.

According to various, but not necessarily all, embodiments there is provided a method for recovering a person positioned above the ground, comprising: positioning a recovery device below and to the side of the person, wherein the recovery device comprises: an expandable base portion; and a person receiving portion configured to receive the person when the expandable base portion is expanded; expanding the expandable base portion to raise the person receiving portion substantially to the height of the person; moving the person sidewards onto the person receiving portion; and contracting the expandable base portion.

The expandable base portion may be inflatable, and the expanding and contracting the inflatable base portion comprise inflating and deflating the inflatable base portion respectively.

The expandable base portion may be expanded to a height of at least 1 metre, and may be expanded to a height of between 1 and 6 metres.

Elongate fastening means may be provided on the inflatable base portion, and the deflating of the inflatable base portion may include unfastening the elongate fastening means to allow air to escape the inflatable base portion.

The expandable base portion may include a plurality of handles, and the method may further comprise stabilising the inflatable base portion by holding the handles.

The person may be positioned on a platform above the ground, and the positioning a recovery device below and to the side of the person may comprise positioning the recovery device below and to the side of the platform.

According to various, but not necessarily all, embodiments there is provided a recovery device for persons suspended in netting, the device comprising: an expandable base portion; and a person receiving portion configured to receive a person suspended in netting above the recovery device when the expandable base portion is expanded.

The expandable base portion may be inflatable. The inflatable base portion may include an aperture and elongate fastening means mounted to the sides of the aperture, wherein the elongate fastening means is configured to close the aperture in the inflatable base portion in a fastened condition, and open the aperture in an unfastened condition, thereby enabling the inflatable base portion to be deflated when the fastening means is in an unfastened condition.

The inflatable base portion may comprise an inflatable bag including at least one baffle, wherein the at least one baffle connects the internal surface of the inflatable bag at a plurality of different locations, in order to retain the bag in a predetermined shape when inflated.

The person receiving portion may include a raised lip positioned around a central part of the person receiving portion, shaped to prevent a person received in the central part from falling out.

Possibly, the expandable base portion is configured to expand to at least 1 metre in height. Possibly, the expandable base portion is configured to expand to between 1 and 6 metres in height.

The person receiving portion may be inflatable. The recovery device may further comprise a one-way valve configured to inhibit airflow from the person receiving portion to the inflatable base portion and to enable airflow from the base portion to the person receiving portion.

The expandable base portion may include a plurality of handles to enable one or more users to hold the expandable base portion when expanded.

The person receiving portion may includes fastening means for fastening a stretcher to the person receiving portion. The fastening means may be a plurality of clips.

According to various, but not necessarily all, embodiments there is provided a recovery device for recovering a person positioned above ground, the device comprising: an expandable base portion; and a person receiving portion configured to receive a person when the expandable base portion is expanded.

The expandable base portion may be inflatable. The inflatable base portion may include an aperture and elongate fastening means mounted to the sides of the aperture, wherein the elongate fastening means is configured to close the aperture in the inflatable base portion in a fastened condition, and open the aperture in an unfastened condition, thereby enabling the inflatable base portion to be deflated when the fastening means is in an unfastened condition.

The inflatable base portion may comprise an inflatable bag including at least one baffle, wherein the at least one baffle connects a plurality of attachment points on the internal surface of the inflatable bag to retain the bag in a predetermined shape when inflated.

The person receiving portion may include a raised lip positioned around a central part of the person receiving portion, shaped to prevent a person received in the central part from falling out.

Possibly, the expandable base portion is configured to expand to at least 1 metre in height. Possibly, the expandable base portion is configured to expand to between 1 and 6 metres in height.

The person receiving portion may be inflatable. The recovery device may further comprise a one-way valve configured to inhibit airflow from the person receiving portion to the inflatable base portion and to enable airflow from the base portion to the person receiving portion.

The expandable base portion may include a plurality of handles to enable one or more users to hold the expandable base portion when expanded.

The person receiving portion may include fastening means for fastening a stretcher to the person receiving portion. The fastening means may be a plurality of clips.

According to various, but not necessarily all, embodiments there is provided examples as claimed in the appended claims.

### BRIEF DESCRIPTION

Some example embodiments will now be described with reference to the accompanying drawings in which:

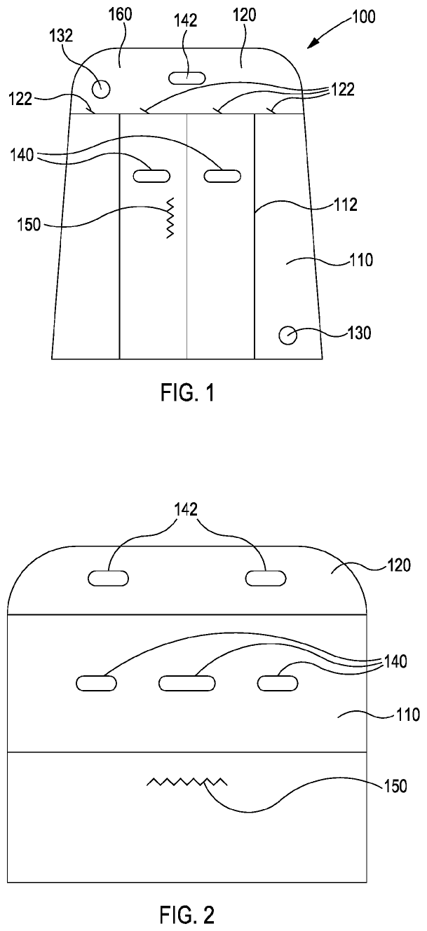

FIG. 1 shows a front view of a first recovery device described herein;

FIG. 2 shows a side view of the example embodiment of FIG. 1;

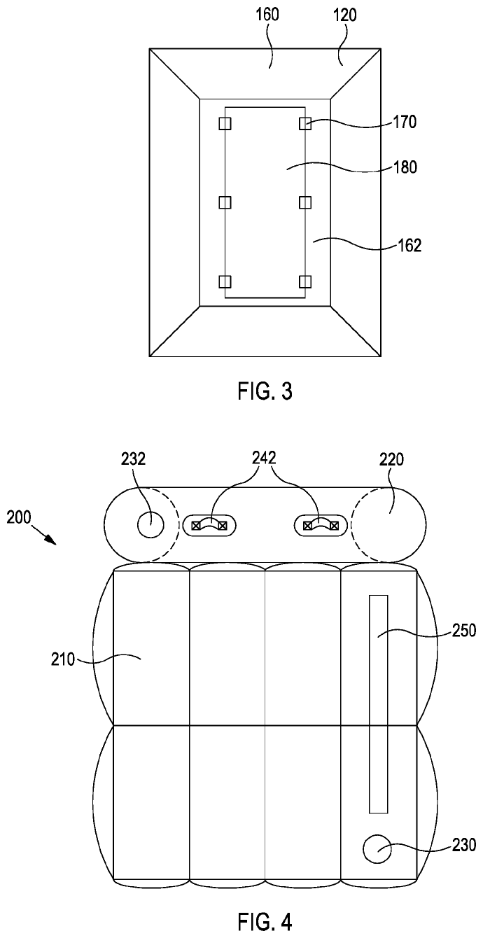

FIG. 3 shows a plan view of the recovery device of FIG. 1;

FIG. 4 shows a front view of a second recovery device described herein;

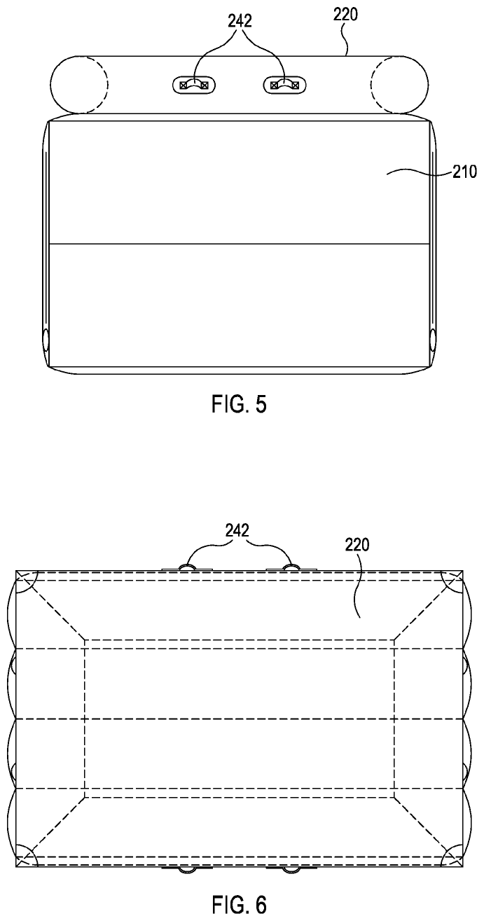

FIG. 5 shows a side view of the example embodiment of FIG. 4;

FIG. 6 shows a plan view of the example embodiment of FIG. 4;

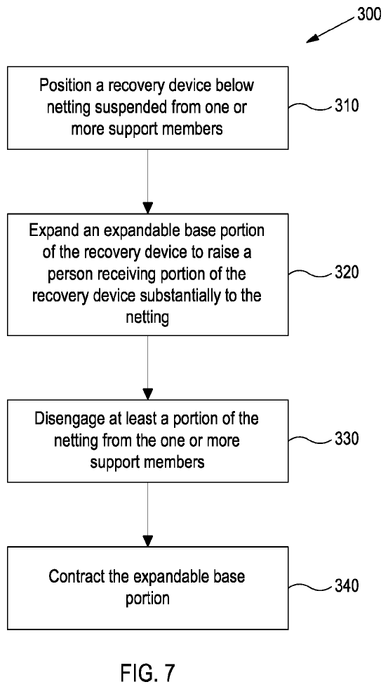

FIG. 7 shows a flow diagram of a first method described herein;

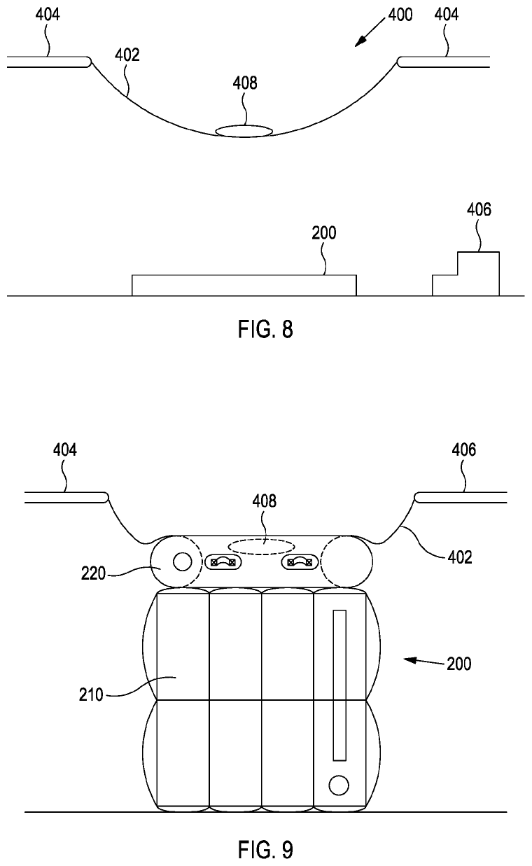

FIG. 8 shows a side view of an example embodiment of a first system described herein, including a recovery device in a contracted condition;

FIG. 9 shows a side view of an example embodiment of the system of FIG. 8, with the recovery device in an expanded condition;

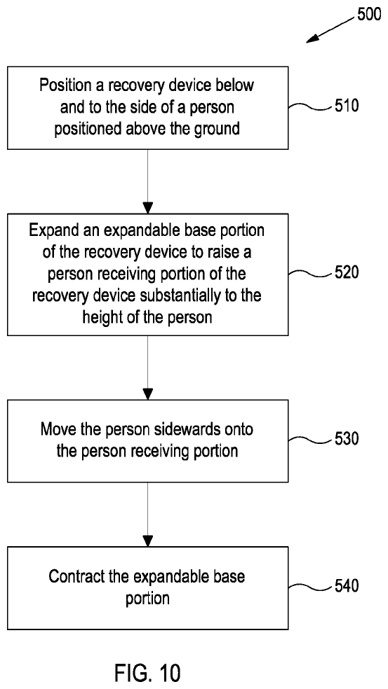

FIG. 10 shows a flow diagram of a second method described herein;

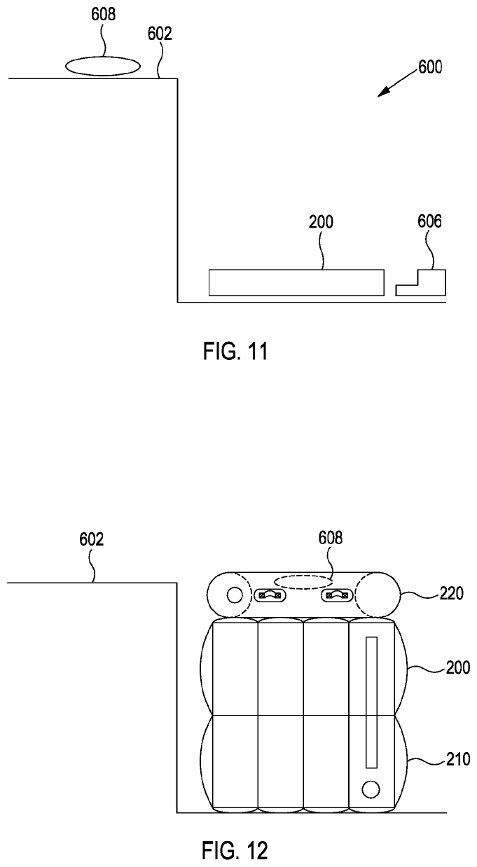

FIG. 11 shows a side view of an example embodiment of a second system described herein, including a recovery device in a contracted condition; and

FIG. 12 shows a side view of an example embodiment of the system of FIG. 11, with the recovery device in an expanded condition.

The figures illustrate a recovery device 100, 200 for persons suspended in netting or positioned above ground, and a system 400 and method 300 including the recovery device 100, 200. The recovery device 100, 200 includes: an expandable base portion 110, 210; and a person receiving portion 120, 220 configured to receive a person when the expandable base portion 110, 210 is expanded.

The recovery device 100, 200 enables an immobile person suspended in netting or on a platform to be recovered safely.

FIGS. 1, 2 & 3 illustrate a first recovery device 100 in front, side and plan views respectively. The recovery device 100 includes an expandable base portion 110 and a person receiving portion 120 positioned on top of the expandable base portion 110. The expandable base portion 110 enables the person receiving portion 120 of the recovery device 100 to be raised substantially to the height of a person suspended in netting above the recovery device 100, or substantially to the height of a person positioned above ground.

FIGS. 1 to 3 show the expandable base portion 110 in an expanded condition. In this example embodiment the expandable base portion 110 is inflatable and comprises an inflatable fabric bag. In some, but not necessarily all embodiments, the fabric bag includes baffles (not shown) inside of the bag, which connects the internal surface of the fabric bag at a plurality of different locations. The internal baffles are configured to retain the bag in a predetermined shape when inflated. In this example embodiment the inflatable base portion 110 is configured to inflate to the shape of a trapezoidal prism. The baffles also cause the inflatable base portion 110 to remain robust when not fully inflated, thus enabling the recovery device 100 to support the weight of a person even when not fully inflated. The recovery device 100 can therefore receive a person at various heights depending on the level of inflation of the inflatable base portion 110.

The inflatable base portion 110 includes an inflation aperture 130 configured to receive an inflation means, as shown in FIG. 1. In some, but not necessarily all embodiments, the inflation means is a blower, which may be a battery powered air blower. In other embodiments, the inflation means may be for instance a compressed gas cylinder.

The inflatable base portion 110 includes a plurality of handles 140 on each side of the inflatable base portion 110 to enable users of the recovery device 100 to stabilize the inflatable base portion 110 when inflated.

The inflatable base portion 110 further includes a deflation aperture, and deflation apertures may be provided on each side of the inflatable base portion 110. In the example of FIGS. 1 & 2 each deflation aperture is closed by an elongate fastening means 150 mounted to the sides of the aperture. The elongate fastening means 150 is shown in FIGS. 1 & 2 in a fastened condition. The elongate fastening means 150 may be selectively unfastened to open the deflation aperture and deflate the base portion 110. For instance, if the elongate fastening means are wholly unfastened the base portion would deflate quickly, and if the elongate fastening means are partially unfastened the base portion would deflate more slowly. In some, but not necessarily all embodiments, the elongate fastening means 150 is a zip. In other embodiments, the elongate fastening means 150 is an elongate Velcro® strip.

FIGS. 1 to 3 also show the person receiving portion 120 configured to receive a person when the expandable base portion 110, 210 is expanded from front, side and plan views respectively. In this example embodiment, the person receiving portion 120 is inflatable.

As shown in FIG. 3, in an inflated condition, the person receiving portion 120 includes a central part 162 onto which the person and/or a stretcher 180 can be positioned. In some, but not necessarily all embodiments, the central part 162 is a rectangular surface and includes fastening means 170 for fastening a stretcher 180 to the person receiving portion 120. The fastening means 170 may be in the form of clips.

In some, but not necessarily all embodiments, the person receiving portion 120 further includes a raised lip 160 positioned around the central part of the person receiving portion. In this example, the raised lip 160 is in the form of inflatable fabric tubing, which, in an inflated condition, extends above each side of the rectangular surface of the central part 162, to prevent a person and/or stretcher 180 positioned on the central part from moving sidewards off the central part 162 and falling out of the person receiving portion 120.

The person receiving portion 120 includes an inflation aperture 132 configured to receive an inflation means, as shown in FIG. 1. The inflation aperture 132 of the person receiving portion 120 enables the person receiving portion 120 to be inflated separately from the base portion 110 if desired. In some, but not necessarily all embodiments, the inflation means is a blower, which may be a battery powered air blower. In other embodiments, the inflation means may be for instance a compressed gas cylinder.

The person receiving portion 120 includes handles 142 on each side of the person receiving portion 120 to enable users of the recovery device 100 to stabilize the person receiving portion 120 when inflated.

In some, but not necessarily all embodiments, the recovery device 100 further comprises one or more one-way valves 122 configured to inhibit airflow from the person receiving portion 120 to the inflatable base portion 110 and to enable airflow from the inflatable base portion 110 to the person receiving portion 120. Each of the one or more one-way valves 122 may be in the form of a movable flap which covers an aperture (not shown) internally connecting the person receiving portion 120 and the inflatable base portion 110. The one or more one-way valves 122 ensure that the person receiving portion 120 remains inflated and retains the person and/or stretcher 180 whilst the inflatable base portion 110 is being deflated.

FIGS. 4 to 6 show a second recovery device 200 in front, side and plan view respectively. The second recovery device 200 is similar to the first recovery device 100, but does not include one or more apertures and one or more way valves internally connecting the inflatable base portion 210 and the inflatable person receiving portion 220. Thus the inflation of the inflatable base portion 210 and the inflatable person receiving portion 220 are carried out entirely separately via the respective inflation apertures 230, 232.

Further, the internal baffles connected to a number of attachment points on the inside of the inflatable base portion 210 bag are configured to retain the inflatable base portion 210 substantially in the shape of a rectangular cuboid when inflated.

The elongate fastening means 250 extend for the majority of the height of the inflatable base portion 210, and may be opened to form a correspondingly shaped deflation aperture.

The second recovery device 200 may include coupling means between the person receiving portion 220 and the inflatable base portion 210 to enable the person receiving portion 220 to be selectively detached from the inflatable base portion 210. The person receiving portion 220 includes handles 242 to enable users to readily lift the person receiving portion 220 from the inflatable base portion 210.

FIG. 7 illustrates a flow chart of a method 300 utilising a recovery device 100, 200 such as those described above to recover a person suspended in netting. By way of example, the method is described below in relation to FIGS. 7, 8 and 9. The second recovery device 200 is referenced, but the first recovery device 100 could instead be used.

The recovery device 200 may initially be provided in an unexpanded condition, and may be folded.

At step 310 in FIG. 7, the recovery device 200 is positioned below netting 402 suspended from one or more support members 404, which may be for instance scaffolding, beams or a roof. FIG. 8 shows the second recovery device 200 in an unexpanded condition positioned below the netting 402. A person 408 may be positioned in the netting 402. Where the unexpanded recovery device 200 is initially folded, the positioning the recovery device 200 may include unfolding the recovery device 200.

A stretcher may be fastened to the person receiving portion 220 of the recovery device 200.

FIG. 8 shows an example system 400 following the carrying out of step 310, including netting 402 suspended between two support members 404. The second recovery device 200 is in an unexpanded condition, and is positioned below the netting 402. Inflation means in the form of a blower 406 is also provided.

At step 320 of FIG. 7, the expandable base portion 210 of the recovery device 200 may be expanded to raise the person receiving portion 220 of the recovery device 200 substantially to the height of the netting 402. This enables the weight of a person 408 positioned in the netting 402 to be fully supported by the recovery device 200. The base portion 210 may be expanded by inflating it using an inflation means, such as a blower 406, as shown in FIG. 8. The expandable base portion 210 may be expanded to a height of at least one metre, and preferably to a height of between 1 and 6 metres.

The blower 406 may be able to inflate the expandable base portion 210 in under two minutes.

In some, but not necessarily all embodiments, the expandable base portion 210 may be expandable to a height of 1 metre. In other embodiments, the expandable base portion 210 may be expandable to a height of 6 metres.

FIG. 9 shows the system 400 including a recovery device 200 in the expanded position following the carrying out of step 320, with a person 408 received in the person receiving portion 210. As the weight of the person 408 is fully supported, the netting 402 is detensioned. The handles 242 of the recovery device 200 may be held by one or more users to stabilize the recovery device 200 when in the expanded condition.

At step 330 of FIG. 7, at least a portion of the netting 402 may be disengaged from the one or more support members 404. In some, but not necessarily all embodiments, the netting 402 may be cut around the person receiving portion 220 using a telescopic cutter or knives.

At step 340 of FIG. 7, the expandable base portion 210 may be contracted, to lower the person receiving portion 220 to the ground. Where the expandable base portion 210 is inflatable, the inflatable base portion 210 may be deflated by unfastening the elongate fastening means 250 to open the one or more deflation apertures.

Once the person receiving portion 220 has been returned to the ground, medical treatment may be initiated on a person 408 received therein. Where a stretcher is fastened to the person receiving portion 220, the stretcher may be unfastened and be used to carry the person 408 to another location.

FIG. 10 illustrates a flow chart of a method 500 utilising a recovery device 100, 200 such as those described above to recover a person positioned above ground on a platform such as a flat roof or a sloped roof. The second recovery device 200 is referenced below, but the first recovery device 100 could instead be used.

The recovery device 200 may initially be provided in an unexpanded condition, and may be folded.

At step 510 in FIG. 10, the recovery device 200 is positioned on the ground and is positioned below and to the side of the platform 602, which in this instance is in the form of a flat roof. FIG. 11 shows the second recovery device 200 in an unexpanded condition positioned below and to the side of the platform 602. A person 608 may be positioned on the platform 602. Where the unexpanded recovery device 200 is initially folded, the positioning the recovery device 200 may include unfolding the recovery device 200.

FIG. 11 shows an example system 600 following the carrying out of step 510, including the platform 602. The second recovery device 200 is in an unexpanded condition, and is positioned below and to the side of the platform 602. Inflation means in the form of a blower 606 is also provided.

At step 520 of FIG. 10, the expandable base portion 210 of the recovery device 200 may be expanded to raise the person receiving portion 220 of the recovery device 200 substantially to the height of the platform 602 and the person 608 on the platform 602. The base portion 210 may be expanded by inflating it using an inflation means, such as a blower 606, as shown in FIG. 11. The expandable base portion 210 may be expanded to a height of at least one metre, and preferably to a height of between 1 and 6 metres.

At step 530 of FIG. 10, the person 608 may be moved sidewards from the platform 608 by recovery personnel (not shown), for instance by lifting the person 608 in a stretcher, and placed into the person receiving portion 220.

FIG. 12 shows the system 600 including a recovery device 200 in the expanded position following the carrying out of step 530, with a person 608 received in the person receiving portion 210. The weight of the person 608 is fully supported by the recovery device. The handles 242 of the recovery device 200 may be held by one or more users to stabilize the recovery device 200 when in the expanded condition.

At step 540 of FIG. 10, the expandable base portion 210 may be contracted, to lower the person receiving portion 220 to the ground. Where the expandable base portion 210 is inflatable, the inflatable base portion 210 may be deflated by unfastening the elongate fastening means 250 to open the one or more deflation apertures.

There are thus described methods, recovery devices and systems that enable a person positioned above ground to be safely retrieved. In an unexpanded condition, the recovery device is compact and light, enabling the device to be stored in a convenient location for quick deployment when required. The recovery device is able to expand and contract quickly, meaning that a person may be retrieved from netting or a platform quickly to enable medical treatment (such as CPR) to be initiated.

It is to be realised that a wide range of amendments may be made without departing from the scope of the invention. For instance, the expandable base portion and the person receiving portion may be a different shape, or be made from different materials. The disengaging of the netting from the one or more support members may be carried out using another method.

Features described in the preceding description may be used in combinations other than the combinations explicitly described above.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Features described in the preceding description may be used in combinations other than the combinations explicitly described above.

Although functions have been described with reference to certain features, those functions may be performable by other features whether described or not.

Although features have been described with reference to certain embodiments, those features may also be present in other embodiments whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer and exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the applicant may seek protection via the claims in respect of any patentable feature or combination of features hereinbefore referred to and/or shown in the drawings whether or not emphasis has been placed thereon.

1.-25. (canceled)

26. A system, comprising:
netting for suspension from one or more support members; and
a recovery device for positioning underneath the netting, including:
an inflatable base portion, wherein the inflatable base portion includes an aperture and an elongate fastener mounted to sides of the aperture, wherein the elongate fastener is configured to close the aperture in the inflatable base portion in a fastened condition, and open the aperture in an unfastened condition, thereby enabling the inflatable base portion to be deflated when the elongate fastener is in an unfastened condition; and
a person receiving portion configured to receive a person suspended in the netting when the inflatable base portion is inflated.

27. The system according to claim 26, wherein the inflatable base portion comprises an inflatable bag including a plurality of baffles, wherein the baffles connect an internal surface of the inflatable bag at a plurality of different locations, in order to retain the inflatable bag in a predetermined shape when inflated.

28. The system according to claim 26, wherein the elongate fastener comprises a zip.

29. The system according to claim 26, wherein the person receiving portion includes a raised lip positioned around a central part of the person receiving portion, shaped to prevent a person received in the central part from falling out.

30. The system according to claim 26, wherein the inflatable base portion is configured to expand to at least 1 meter in height.

31. The system according to claim 30, wherein the inflatable base portion is configured to expand to between 1 and 6 meters in height.

32. The system according to claim 26, wherein the person receiving portion is inflatable.

33. The system according to claim 32, wherein the recovery device further comprises a one-way valve configured to inhibit airflow from the person receiving portion to the inflatable base portion and to enable airflow from the inflatable base portion to the person receiving portion.

34. The system according to claim 26, wherein the inflatable base portion includes a plurality of handles to enable one or more users to hold the inflatable base portion when inflated.

35. The system according to claim 26, in which the person receiving portion includes a fastener for fastening a stretcher to the person receiving portion.

36. The system according to claim 35, wherein the fastener for fastening a stretcher to the person receiving portion is a plurality of clips.

37. The system according to claim 26, further comprising a stretcher that is mountable to the person receiving portion.

38. The system according to claim 26, wherein the netting and recovery device are arranged such that when the recovery device is in an uninflated condition, the recovery device is vertically spaced from the netting, and when the recovery device is in an inflated condition, the recovery device is in contact with the netting.

39. The system according to claim 26, further comprising an inflator for inflating the inflatable base portion and the person receiving portion.

40. A method for recovering persons suspended in netting comprising:
positioning a recovery device below netting suspended from one or more support members, wherein the recovery device comprises:
an inflatable base portion, wherein the inflatable base portion includes an aperture and elongate fastener mounted to sides of the aperture, wherein the elongate fastener is configured to close the aperture in the inflatable base portion in a fastened condition, and open the aperture in an unfastened condition, thereby enabling the inflatable base portion to be deflated when the elongate fastener is in an unfastened condition; and
a person receiving portion configured to receive a person suspended in the netting when the inflatable base portion is inflated;
inflating the inflatable base portion to raise the person receiving portion substantially to the netting;
disengaging at least a portion of the netting from the one or more support members; and
contracting the inflatable base portion.

41. The method according to claim 40, wherein the inflatable base portion is expanded to a height of at least 1 meter.

42. The method according to claim 40, wherein the disengaging the at least a portion of the netting from the one or more support members includes cutting the netting around the person receiving portion.

43. The method according to claim 40, wherein inflatable base portion further includes an elongate fastener, further comprising deflating the inflatable base portion by unfastening the elongate fastener to allow air to escape the inflatable base portion.

44. The method according to claim 40, wherein the inflatable base portion further includes a plurality of handles, further comprising stabilizing the inflatable base portion by holding the plurality of handles.

45. A recovery device for persons suspended in netting, the recovery device comprising:
an inflatable base portion, wherein the inflatable base portion includes an aperture and elongate fastener mounted to sides of the aperture, wherein the elongate fastener is configured to close the aperture in the inflatable base portion in a fastened condition, and open the aperture in an unfastened condition, thereby enabling the inflatable base portion to be deflated when the elongate fastener is in an unfastened condition; and
a person receiving portion configured to receive a person suspended in netting above the recovery device when the inflatable base portion is inflated.
